(19) United States
(12) Patent Application Publication
(10) Pub. No.: US 2001/0027465 A1
(43) Pub. Date: Oct. 4, 2001

(54) Method of switching process data as well as method of creating user-specific data and data created by means of this method

(76) Inventor: Stephan Hammelbacher, Oberhaching (DE)

Correspondence Address: Harness, Dickey & Pierce, P.L.C., P.O. Box 828, Bloomfield Hills, MI, 48303, US

(21) Appl. No.: 09/737,028

(22) Filed: Apr. 16, 2001

(30) Foreign Application Priority Data
Dec. 15, 1999 (DE) 99 125 040.8

(51) Int. Cl. G06F 15/16

(52) U.S. Cl. 709/201

(57) ABSTRACT

There is explained inter alia a method of switching process data, wherein a program stored in the memory of a program computer is carried out by at least one processor in a process, which is distinguishable from other processes executed by this processor with the aid of a process date. The process date is transferred from a first interface for the data input and data output to a second interface (step 164). In doing so a process is switched. By means of the process date data related to the execution of the program are transferred between the program computer and the second interface (step 168).

The present invention relates to a method, wherein a program stored in the memory of a program computer is executed by at least one processor in a process which is distinguishable from other processes executed by this processor with the aid of a process date. Having regard to the process date, data related to the execution of the program are transmitted between the computer and a first interface for the data input and/or data output.

Such a method can, for example, be implemented with the aid of program components of the company CITRIX or the company Microsoft Ltd. (Windows 2000). The program components are available on the Internet under the address www.citrix.com. For demonstration purposes, the remote use of the program WORD of the company MICROSOFT Ltd. is offered under this address. The user has the possibility of writing with WORD and of storing the data written on a data carrier in his computer or of printing them out by his local printer. During the execution of WORD, the user is assigned memory space and a process number in the remote program computer. In addition, the program components of the company CITRIX offer the possibility of transmitting the outputs transferred to the user and the inputs entered by the user, respectively, also to a further interface for the data input or data output. This method is referred to as mirroring. For the mirroring, the process number assigned to the user has to be known in a further remote computer. In order to find out the process number, the operator of the remote computer has to monitor the processes in the program computer and to register new processes on his own.

It is the object of the invention to amend the method mentioned at the beginning such that additional applicabilities result.

This object is solved by a method having the steps indicated in claim 1. Embodiments are given in the subclaims.

The invention is based on the recognition that new applicabilities result in connection with the mirroring if a process executed in the program computer can be switched. A simple possibility of such a switching consists in causing from the first interface that the process date or data for determining the process date are transferred to a second interface. With the aid of the process date, then data related to the execution of the program in the program computer are transmitted between the program computer and the second interface.

By means of the transfer caused by the first interface it is achieved that the point of time for switching the process can be determined by an operator of the first interface. In addition, the second interface can be freely chosen by the operator of the first interface. In doing so, it is possible to switch a process in a program computer, in a way similar to a telephone call, at any times and to any destinations.

In one embodiment of the method according to the invention, the program is a program which is used by a user from the first interface. For example, application programs or operating systems can be used remotely. If questions arise during the execution of the program by the user, the user has, when making a request to the manufacturer of the program, in addition, the possibility of causing the transmission of the process date to the manufacturer. The user either knows the process date or he can automatically cause the transmission of the process date from his interface. With the aid of the process date, the data related to the execution of the program can also be transferred to the second interface, i.e. to the interface of the manufacturer. Thus, the manufacturer can, in a way better than up to now, support the user when answering his questions.

In an alternative embodiment the program is a program which is controlled by a user from a user interface. Thus, three interfaces are involved in the method, namely the first interface, the second interface and the user interface. The transfer of the process date or the data for determining the process date is caused by the first interface, i.e. an interface different from the user interface. In addition to the user interface and an interface of the manufacturer, thus interfaces of third parties can be included in the method. For example, the first interface is an interface from which the processes are switched to several manufacturers. The first interface is thus a switching center from which the processes are switched to a plurality of computers.

Such a proceeding allows the manufacturers for example to first of all employ a service provider at the first interface, who solves simple problems on his own. Only if special knowledge is required, the switching to the manufacturer takes place. On the other hand, the service provider works for a plurality of manufacturers such that the computing technology operated by him is well working to capacity.

In embodiments, the first interface, the second interface and/or the third interface are included in remote computers which are connected to the program computer via a data communications network. In contrast to a direct connection of the interfaces to the computer of the user, such as in the form of terminals, a data communications network allows the interfaces to be set up far from the program computer. Thus, the switching cannot only be carried out within a building but worldwide.

In another embodiment, the same data, which are transferred between the program computer and the interface used by the user, are transferred to the first interface and/or the second interface. The data which are output on the screen or on other output devices of the user are also output on the first interface and/or the second interface, i.e. mirrored. Conversely, it is also visible at the first interface and the second interface which data are entered by the user.

In a further embodiment the process date is transferred to the first interface. Afterwards, the process date transferred is transmitted from the first interface to the second interface. The transfer of the process date to the first interface is a simple possibility of causing the transfer of the process date from the first interface as the process date is available in the first interface for the further switching process.

In one embodiment the process date is transferred via a data communications network or via a telephone network. The data communications network is for example the same data communications network via which the remote computers with the interfaces are connected to the program computer. For example, the Internet is used as data communications network. By the use of latest mail technologies and latest programming languages, such as the programming language JAVA, the transmission of the process date can be carried out in a simple manner. A transmission via the telephone network is chosen if, in addition to the process date, still further data are to be transferred which can orally be transmitted faster.

In one embodiment the user enters in a starting phase lasting for several weeks, several months or even several years extensive user-specific program parts of the program or parts of an extensive user-specific database required for the use of the program without having unrestricted access to the instructions of the application program. The use of the program as agreed is only possible after the starting phase. Only after the termination of the starting phase the user gets unrestricted access to the instructions of the application program. This embodiment is based on the fact that during the starting phase a switching of the process is often required, in which process the input of the user-specific program parts or the user-specific database takes place since during the adaptation many questions arise which can either be already answered by a service provider without any special knowledge or only by the manufacturer of the program, i.e. with the help of special knowledge.

The invention further relates to a method of creating user-specific data, wherein an application program is stored in the memory of a computer. A user uses functions of the application program from a remote service use computer via a data communications network.

Such a method can, for example, be implemented with the aid of program components of the company Microsoft Ltd., CITRIX or Netmanage. The program components are available on the Internet under the address www.citrix.com. For demonstration purposes, the remote use of the program WORD of the company MICROSOFT Ltd. is offered under this address. The user has the possibility of writing with WORD and of storing the written data on a data carrier in his computer or of printing them out on his local printer. The application program itself does not have to be purchased by the user. However, the use of the data communications network, which is not always free of cost, is disadvantageous.

Before the user can use the program as agreed, many application programs require an extensive adaptation of the program to the requirements of the user and/or the input of a large number of user-specific data into a database. Methods of creating user-specific data are known, wherein the user first has to obtain a computer and the associated application program or has to operate the program in a computing center. Afterwards, the user starts to adapt the user-specific data. In doing so, the user often has to be supported by the manufacturer of the application program. This starting phase often lasts for several weeks or several months, and in exceptional cases even for several years, i.e. several man-months or man-years are required. In particular in the case of programs relating to business management or programs for the support of the management extensive adaptations to the respective user are required since the individual companies differ from one another in their structure.

It is the object of the second aspect of the invention to provide a method of creating user-specific data, which method allows an extensive adaptation of the application program at a lower expense. Further, the invention relates to the user-specific data created by means of this method.

The object concerning the method is solved by the steps indicated in claim 1. Embodiments are given in the subclaims.

The invention is based on the recognition that the expense for the user, when creating user-specific data, can only be reduced if the renewal rate on the field of computer technology and network technology is taken into account. The measure of the renewal rate can be taken from the fact that computers which are to be referred to as standard computers have, for example, twice as much working storage every year and an operating speed almost twice as high compared to the previous year. Moreover, the computers become obsolete very fast since new technologies are used, such as new bus systems or the Internet.

Therefore, in the method according to the invention, the user enters in a starting phase user-specific program parts of the application program or a user-specific database required for the use of the program. During the starting phase the user has no unrestricted access to the instructions of the application program and/or the database. That means, for example, that he cannot copy and/or archive the program or program parts which are not user-specific, nor can he copy and/or archive the database. Copying means the doubling of data for the active use. Archiving is the doubling of data for the retention. The archived data will only be used in the case of data losses. Only after the starting phase has been terminated, the user gets unrestricted access to the instructions of the application program. In one embodiment, the program and preferably also the user-specific data are transferred to the user only after the termination of the starting phase. This way of proceeding allows to delay the point of time at which the user has to purchase the program. Furthermore, he is often able to delay the point of time for purchasing a new computer since for the adaptation also an older computer and a customary browser is sufficient.

By using the method according to the invention, the user can still decide in the starting phase, i.e. before the purchase of the application program and before the purchase of associated computing technology, whether the application program fulfills his purposes. The expense during the introduction of a program is considerably decreased by the use of the method according to the invention.

During the starting phase the adaptations carried out by the user are stored. When the starting phase is interrupted, the adaptation can be continued at the position which it had before the interruption.

In an alternative the user-specific data are parts of a database used by the application program. The database includes data entered by the user. Alternatively or additionally, the user-specific data are parts of the instruction sequence of the application program. For example, the user-specific data are included in the instruction sequence of the application program by the manufacturer before it is transmitted to the user.

If after the termination of the starting phase the program including the user-specific data is transmitted to the user or a provider of computing center service, for example, via the data communications network or with the aid of an optical or magnetic data carrier, the user has the possibility of installing the program and the user-specific data on his own computers. This allows the use in an own data communications network. In addition, the user-specific data can be extended by data to which third parties should have no access. There are, however, also other methods in order to allow the user the unrestricted access to the program. For example, when using the program, he can be given extended access rights via a data communications network, which rights for example make it possible for him to reproduce the program for his purposes, for example by means of a so-called download.

In one embodiment of the method according to the invention the remote use of the functions of the application program by the user is displayed in a computer of a service provider or in a computer of the manufacturer of the program. The service provided by the service provider is the remote use of the application program. The remote use in particular comprises inputs of the user and outputs of the application program for the user which are output on a screen in the remote service use computer or in a data memory of the remote service use computer. The display of the remote use in a third computer is also known as “mirroring”. The “mirroring” is supported by the program components mentioned at the beginning and offered by the company CITRIX. The service provider or the manufacturer “mirror” the remote use of the user dependent on their needs. By means of the “mirroring” it is achieved that user and service provider or user and manufacturer work in the same development environment, use the same data stock and have the same displays on their display units. This considerably facilitates the creation of the user-specific data since errors of the user can simply and early be recognized by the manufacturer. The embodiment is based on the recognition that the adaptation procedure is considerably facilitated if, on the one hand, it is visible for the manufacturer what is seen and entered by the user and that, on the other hand, errors are excluded which are to be put down to the fact that the user and the manufacturer or service provider use different computers. In the embodiment the application program is executed on one computer only. Only the outputs of this computer are transmitted to the user or the service provider or manufacturer. The manufacturer can quickly answer requests of the user with regard to errors since he exactly knows the computer on which the application program is executed. By means of the embodiment, the expense for the user as well as the expense of time and staff for the service provider or manufacturer is reduced.

In one embodiment messages are exchanged between the user and the service provider or the user and the manufacturer, respectively, which messages support the use of the functions and/or the adaptation. The messages are, for example, exchanged via the telephone network or via the data communications network. For example, an information box can be used which displays the messages of the respective other one on a display unit. The exchange of messages in combination with the “mirroring” guarantees a particularly effective and simple support of the user.

Another embodiment is based on the recognition that during the introduction of a program the user first raises relatively simple questions, such as to the purpose of use or to the advantages of the program compared to other programs for the same purpose of use. After these simple questions, however, in particular during the adaptation, questions are increasingly raised which can be answered only with the aid of a deeper technical understanding of the functioning of the application program. The expense for the manufacturer when introducing an application program can be lowered if the program is introduced in two phases. Therefore, in this embodiment first of all a connection for the transmission of the messages and/or for displaying the remote use is set up between the user and the service provider. Only afterwards a connection between the user and the manufacturer is set up. The operator of the computer of the service provider does not have to have special knowledge for supporting the user. Only the operator at the computer of the manufacturer has special knowledge. The manufacturer of the application program basically only has an expense for the second phase of the program introduction. A method has been developed, wherein the expense for the introduction of a program is considerably reduced on the user side as well as on the manufacturer side.

In a next embodiment the service provider switches the user to the manufacturer. During the switching, a process number is passed on with the aid of which the functions used by the user can be displayed in the computer of the service provider and/or in the computer of the manufacturer. The user is, for example, switched to the manufacturer via a telephone network or the data communications network. The forwarding of the process number allows to include the manufacturer in supporting the user without the user having to interrupt the use of the application program. The manufacturer, on the other hand, does not have to determine the process number by means of a more costly method.

In one embodiment of the method according to the invention several application programs are stored in the memory of the computer with the application program and in particular programs of different manufacturers. By this measure for example the computers of the service provider, on which the remote use is displayed, can be better made use of. In this embodiment, too, the operators do not have to have any special knowledge about the application programs.

Further, the invention relates to user-specific data which have been created by the method according to the invention or its embodiments. The user-specific data are for example program data or data of a database. The technical effects mentioned above do also apply to the user-specific data.

In the following, embodiments of the invention are explained with reference to the enclosed drawings.

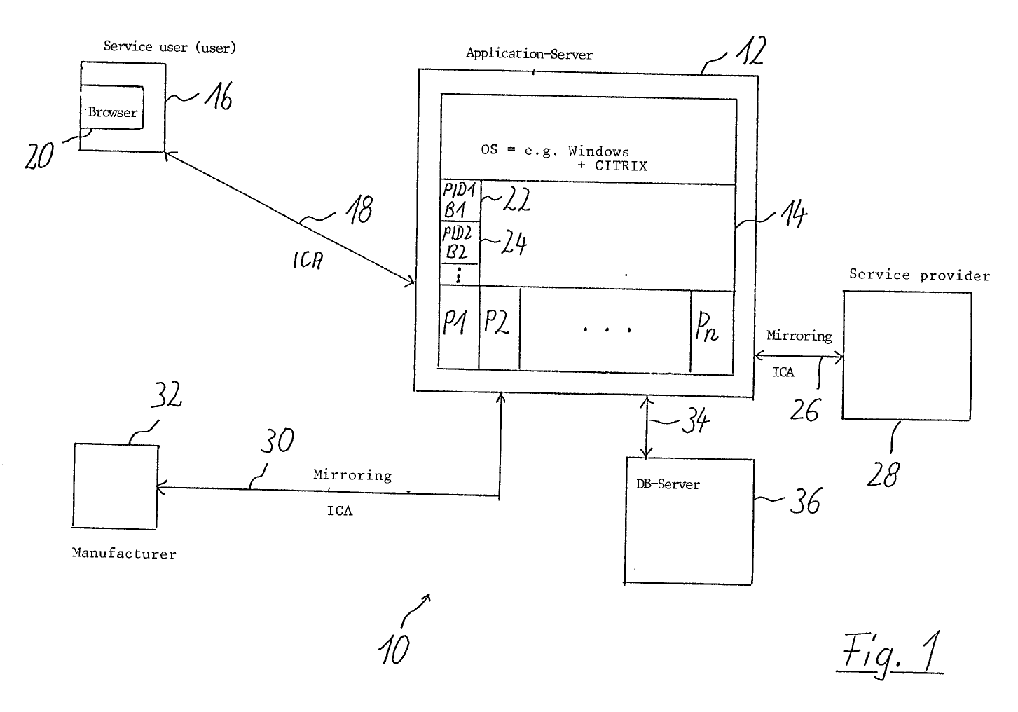

FIG. 1 shows a data communications network for the remote use of application programs.

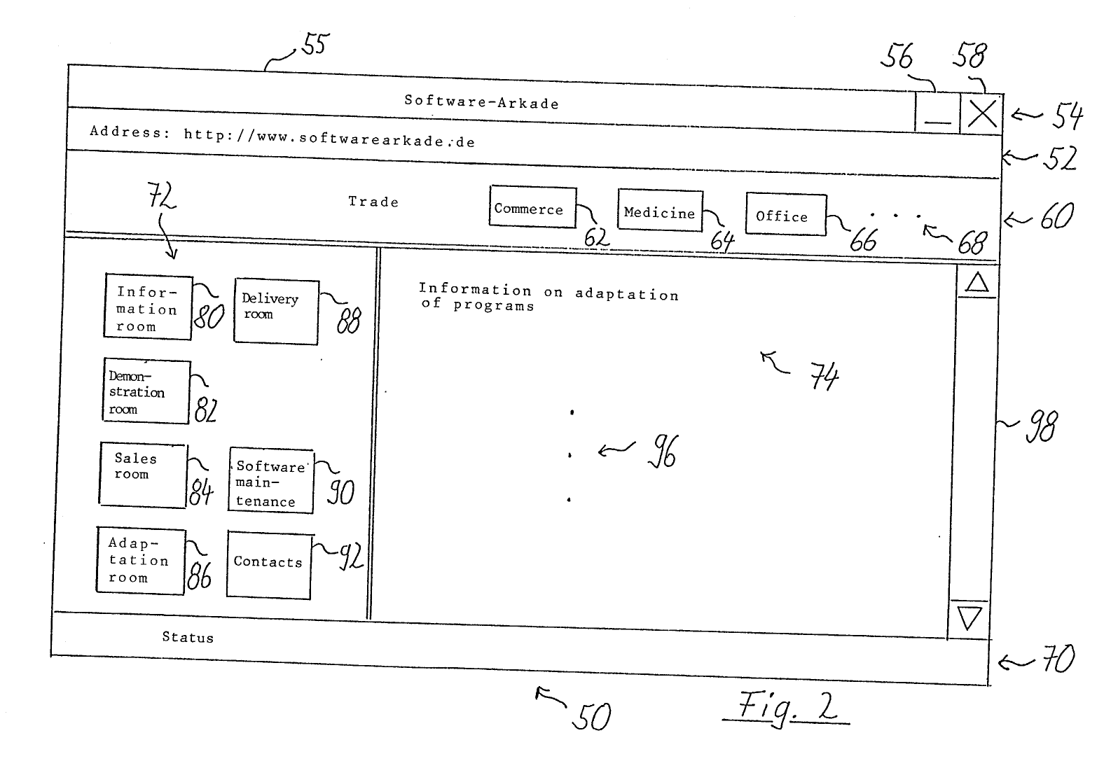

FIG. 2 shows the display on the screen of a service use computer at the beginning of the remote use.

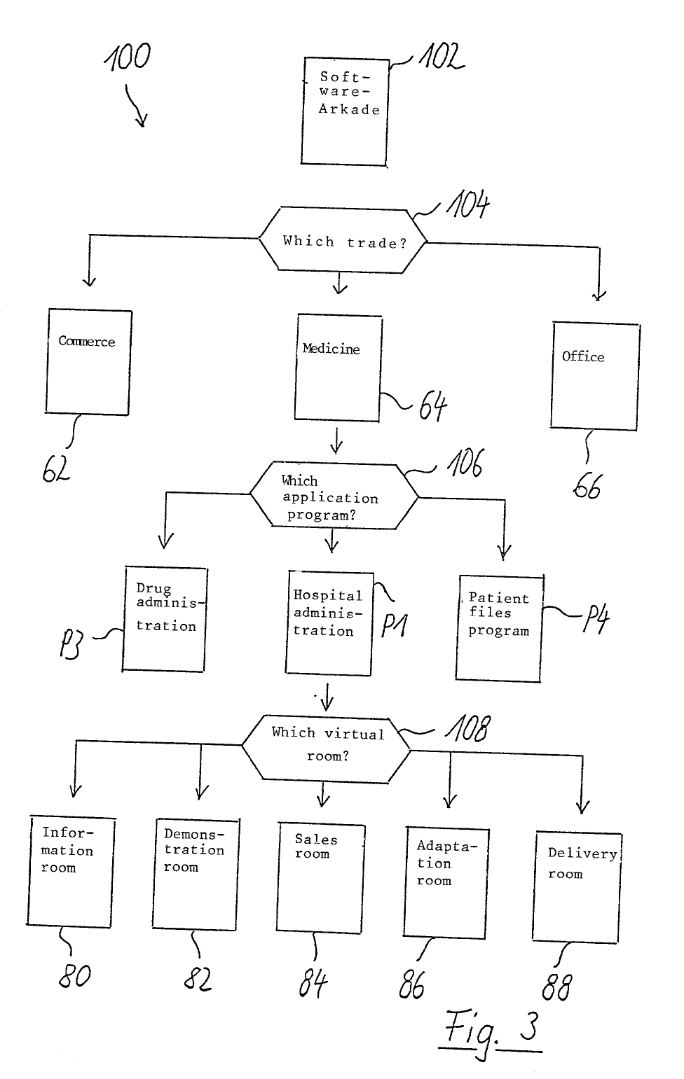

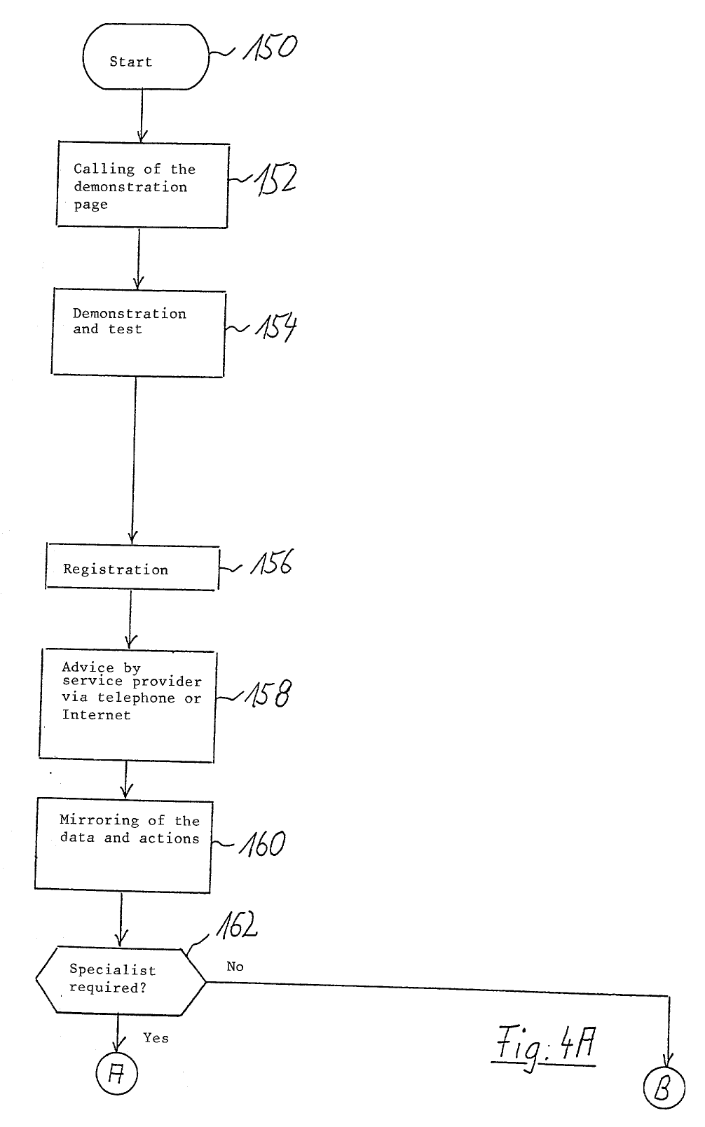

FIG. 3 shows a hierarchy for the selection of the application program.

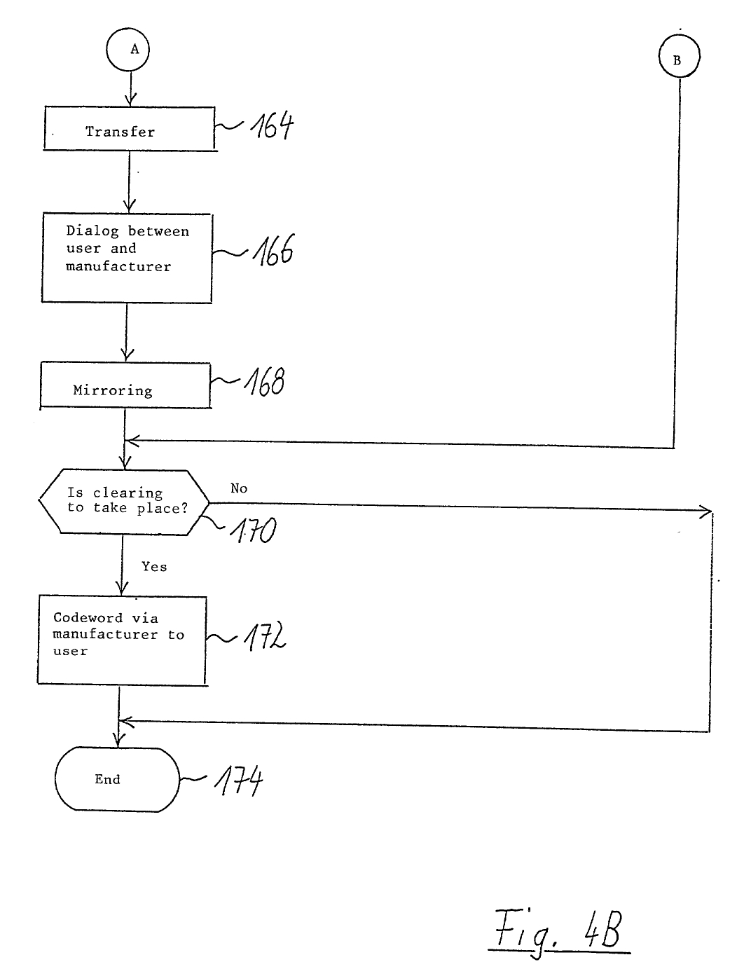

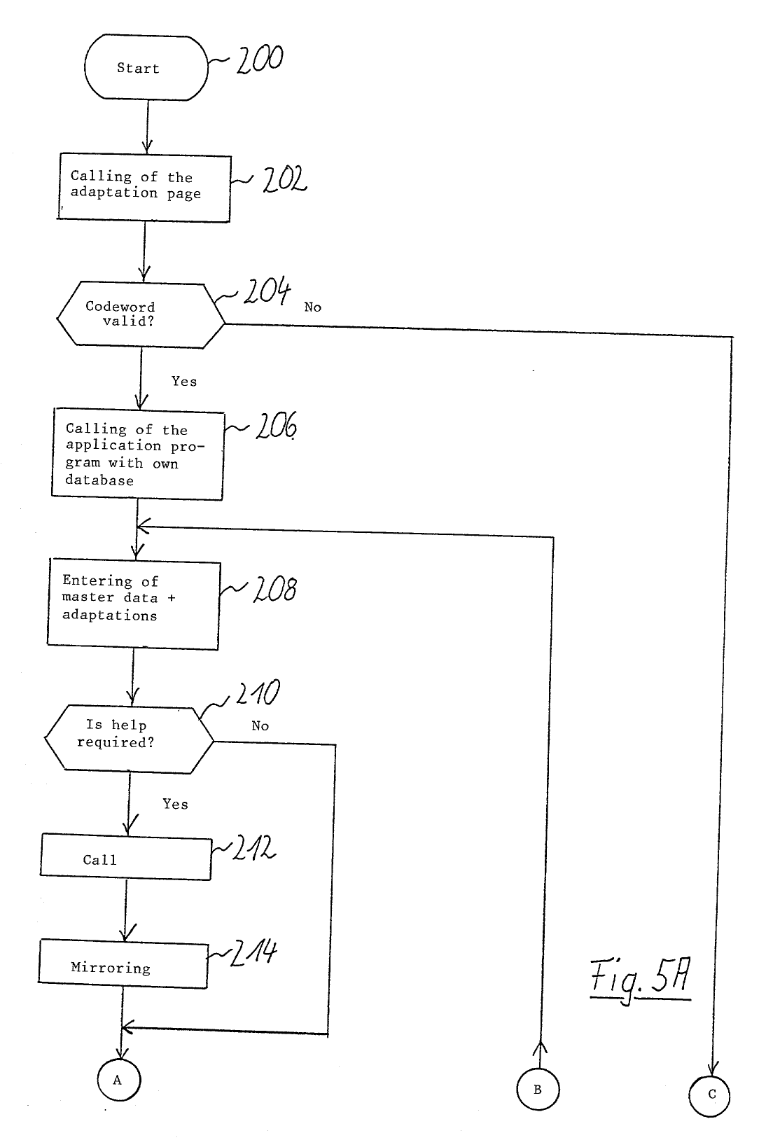

FIGS. 4A and 4B show the steps carried out during the remote use.

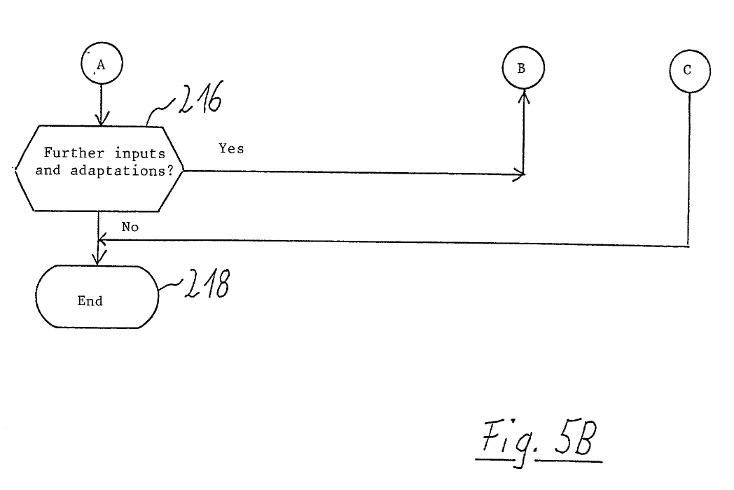

FIGS. 5A and 5B show the steps carried out when creating user-specific data of the application program.

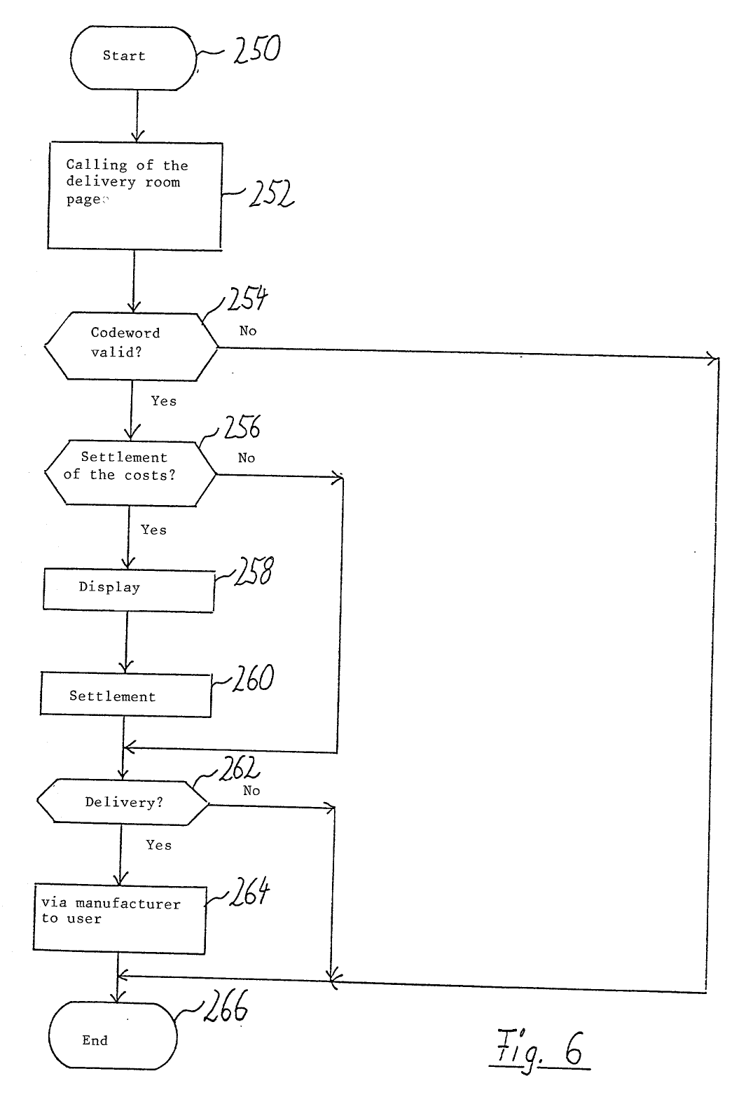

FIG. 6 shows the steps which are to be carried out for the delivery of the application program.

FIG. 1 shows the Internet 10 which serves for the remote use of application programs P1, P2 to Pn, n being a natural number of greater than three. The application programs P1 to Pn are stored in a service provisioning computer 12, which is also referred to as application server. The application program P1 is, for example, a program for the administration in a hospital. In order to make the work with the application program P1 possible, the details regarding the hospital to be administered, such as the number of beds, the number of operating rooms and patterns for the forms used in the hospital, have to be entered. The application program P2 is, for example, a management information system. The application program Pn is a business management program, such as the program SAP.

The application programs P1 to Pn are stored in a memory unit 14 of the service provisioning computer 12. In the memory unit 14, there is further an operating system OS, such as the operating system WINDOWS NT Terminal Server Edition of the company MICROSOFT Ltd. or WINDOWS 2000. The operating system OS further includes program components for the remote use of the application programs P1 to Pn. Such components are offered on the Internet, for example by the company CITRIX under the address www.citrix.com. The program components of the company CITRIX allow a remote use of the application programs P1 to Pn from service use computers, from which in FIG. 1 a service use computer 16 is illustrated. Between the service use computer 16 and the service provisioning computer 12 there is an Internet connection 18 on which data are transmitted according to the Internet protocol TCP/IP (Transmission Control Protocol/Internet Protocol). On the side of the service use computer 16 a commercially available data display program is required, with which data can be searched for on the Internet and can be displayed. The data display program 20 is also referred to as browser. The remote use is made possible by the program components of the company CITRIX, a special narrowband protocol ICA (Independent computing Architecture) being used on the Internet connection 18. In another embodiment program components are used which are offered under the Internet address www.netmanage.com. The protocol ICA is very narrowband, since when using an application program, such as the application program P1, only data have to be transferred to the service use computer 16 which concern the display on the screen of the service use computer 16 or other outputs in the service use computer 16. In the other direction, i.e. from the service use computer 16 to the service provisioning computer 12, only such data have to be transferred with the aid of the protocol ICA, which concern inputs of an operator into the service use computer 16.

The operator of the service use computer 16 is the first user B1 of the application program P1. Data created during the use of the application program P1 by the user B1 are stored in the memory unit 14 in a memory area 22. Inter alia, there is stored an identity number PID1, with the aid of which the data received according to the protocol ICA are assigned to the user B1. In addition, the identity number PID1 is used to forward output data according to protocol ICA to the service use computer 16.

For other users of the application program P1, there are in the memory unit 14 own memory areas, too, one memory area 24 of which for a user B2, which has the identity number PID2, being illustrated in FIG. 1.

Via the Internet there is further set up an Internet connection 26 between the service provisioning computer 12 and a computer 28, which is operated by a service provider. The service provider makes the remote use of the application programs P1 to Pn available in the service provisioning computer 12. On the Internet connection 26 data are transmitted according to Internet protocol TCP/IP as well as according to protocol ICA. From the computer 28, the identity numbers PID1, PID2 can be determined. The program components of the company CITRIX allow in a method called “mirroring” that when indicating the identity number PID1, the data transferred on the Internet connection 18 are also transferred on the Internet connection 26. In doing so, on a display unit of the computer 28 the same information as on the display unit of the service use computer 16 can be displayed.

If necessary, an Internet connection 30 is set up via the Internet 10 between the service provisioning computer 12 and a computer 32 which is operated by the manufacturer of the application program P1. On the Internet connection 30 data are transmitted according to Internet protocol TCP/IP and according to protocol ICA. If the identity number PID1 is transmitted to an operator of the computer 32 from an operator of the computer 16 or the computer 28, the data transmitted on the Internet connection 18 can also be mirrored via the Internet connection 32. Thus, also on a display unit of the computer 32 the data displayed on the display unit of the service provisioning computer 16 are displayed.

In the case of application programs which require the use of an extensive database, the memory areas 22, 24 are too small so that an Internet connection 34 is set up between the service provisioning computer 12 and a database computer 36. On the Internet connection 34 data are transmitted according to Internet protocol TCP/IP. Further, for the access to the respective database a database language is used, such as the language SQL (Structured Query Language).

In another embodiment, the WEB server is in a computer different from the service provisioning computer 12.

FIG. 2 shows the display of a so-called WEB page 50 on the display unit of the service use computer 16, see FIG. 1. The WEB page 50 is displayed in the service use computer 16 after the operator of the service use computer 16 has set up an Internet connection to the service provisioning computer 12. The service provisioning computer 12 can, for example, be reached under the address http://www.softwarearkade.de. This address is displayed in an address bar 52 of the WEB page 50. Above the address bar 52, there is a title bar 54, in which in a title field 55 “Software-Arkade” is given as title. The title bar 54 further includes a minimize button 56 for minimizing the display of the WEB page 50 and a close button 58 for terminating the display of the WEB page 50 on the display unit.

Below the address bar 52, there is displayed a trade selection bar 60, comprising buttons for selecting various trades. In FIG. 2, buttons 62, 64 and 66 are illustrated for the trades commerce, medicine and office, respectively. The dots 68 indicate buttons for further trades.

At the lower edge of the display unit, a status bar 70 is shown, in which, for example, the respective connection status is displayed. Between the trade selection bar 60 and the status bar 70, there is a room selection field 72 as well as an information field 74 next thereto. In the room selection field 72 there are buttons 80 to 92, which, in the following order, serve for the selection of an information room, a demonstration room, a sales room, an adaptation room, a delivery room, a software maintenance room and a contact room. The rooms mentioned are so-called virtual rooms which are only displayed on the display unit. The buttons 82 to 90 can only be actuated after the selection of an application program P1 to Pn with the aid of the trade bar 60 or the button 80. The selection process is explained below with reference to FIG. 3. The content of the virtual rooms refers after the selection to the selected application program P1 to Pn, see FIG. 1.

In the information field 74 information for adapting programs is displayed, which explains to the service user the advantages of a remote use and the steps which have to be carried out. Dots 96 indicate further information in the information field 74 which information can be displayed by actuating a vertical scroll bar 98 at the right hand edge of the display unit.

When actuating the button 80 for the virtual information room, and after an application program P1 to Pn has been selected, the features of the selected application program are displayed in the information field 74. If the user actuates the button 82 for the virtual demonstration room, then the selected application program, for example the application program P1, can be used. In doing so, a “mirroring” by the service provider or the manufacturer of the application program is possible. The steps which are then carried out are explained with reference to FIGS. 4A and 4B.

If the button 84 for the virtual sales room is actuated, the prices and the terms of delivery for the selected application program are displayed. The button 68 leading to the adaptation room is actuated in order to adapt the selected application program to the requirements of the operator of the service use computer 16. The steps which have to be carried out in this connection will be explained below with reference to FIGS. 5A and 5B.

In the delivery room, which can be reached by actuating the button 88, the costs are displayed which have been incurred up to now by the user during the adaptation of the program to his requirements. Further, the user can decide in the virtual delivery room to purchase the version of the selected application program which has been adapted to his requirements. The steps concerning the delivery room will be explained below with reference to FIG. 6.

The button 90 leads to the display of information on the better use of the selected application program and is especially provided for experienced and long-standing users. Via the button 92 data concerning the service provider can be displayed, i.e. concerning the owner of the WEB page 50.

FIG. 3 shows a hierarchy 100 for the selection of an application program P1 to Pn. The selection either takes place via the trade bar 60, the actuation of the button 80 for the virtual information room or the use of a search function. After calling the WEB page 50, see FIG. 2, and an associated program 102 of the service provider, a trade is selected in a step 104. For this, for example the buttons 62 to 66 of the trade bar 60 are used. If an operator actuates the button 80, without having actuated one of the buttons 62 to 66 of the trade bar 60 before, then in the information field 74 buttons for the selection of a trade are displayed. It is assumed that the operator actuates the button 64 for the trade medicine and thus shows that he is only interested in application programs for the field medicine.

In a next step 106 buttons are displayed in the information field 74, by means of which the application program P1 for the hospital administration, an application program P3 for a drug administration or an application program P4 for the administration of the patient files can be selected. It is assumed that the operator decides on the button which is associated to the application program P1, i.e. to the hospital administration.

If the operator has selected one of the application programs, the buttons 80 to 90 concern this application program only. In a step 108, the operator selects a specific virtual room by means of the buttons 80 to 88.

For the other trades, such as commerce or office, there are also several application programs. For each of these application programs, the virtual rooms are specially adapted so that the steps concerning the application program selected can be carried out. If the service provider extends his offer by an application program, he only has to copy a folder with the software for the virtual rooms into a new directory, which is assigned to the new application program. Afterwards, the virtual rooms are to be adapted to the new application program.

The FIGS. 4A and 4B show the steps implemented when remotely using an application program. The method starts with a step 150 by actuating a button 82 for the virtual demonstration room, see FIG. 2. In a next step 152, a demonstration page is displayed on the display unit of the service use computer 16, which page allows a demonstration and the test of the application program selected. In a step 154, the user has functions of the application program demonstrated and, in addition, tests functions of the selected application program on his own.

The program components of the company CITRIX mentioned with regard to the description of FIG. 1 assign a memory area and an identity number to the user, here the memory area 22 and the identity number PID1. Due to the Internet connection 26 between the service provisioning computer and the computer 28, the service provider recognizes this operation, see step 156. The service provider can send a message to the service use computer 16, for example by using a so-called chat box. For example, he asks the operator of the service use computer 16 “Can I help you?”. The service provider can also be directly called by the user, for example via the telephone network. After calling, the mirroring takes place.

In a step 158, the future user of the application program is given advice by the service provider. In addition to the chat box, also a telephone network can be used for giving advice.

The service provider has no special knowledge about the selected application program and therefore, first of all answers the simple questions of the user. In a step 160, the service provider “mirrors” the Internet connection 18 in order to display the same information which is displayed on the display unit of the service use computer 16 on the display unit of the computer 28. In doing so, the identity number PID1 has to be indicated. Due to the “mirroring” the operator of the service use computer 16 does no longer have to explain to the service provider, what is currently displayed on the display unit of the service use computer 16. When “mirroring”, the service provider, in addition, can interfere in the use of the application program by the service user in order to demonstrate functions of the application program.

If in a step 162 a question arises which requires special knowledge with regard to the application program, the future user is switched to the manufacturer by the service provider. The switching takes place automatically by calling the Internet address of the computer 32. Upon switching, the identity number PID1 is forwarded to the computer 32. With the aid of the identity number PID1 the Internet connection 18 is also “mirrored” from the computer 32.

In a step 166, manufacturer and user have a dialog by using a chat box or a telephone line. The “mirroring” to the computer 32 facilitates the explanation given by the manufacturer since he directly sees on his display unit what is displayed on the display unit of the user, see step 168. After step 168 follows a step 170.

The step 170 is also directly implemented after step 162 if no questions arise, the answering of which requires special knowledge. In step 170 the future user has to decide whether the program is suitable for his purposes and whether he wants to adapt user-specific data to his requirements when using them remotely. If such an adaptation is to take place, the user is given a codeword from the service provider or the manufacturer in a step 172. Afterwards, the method concerning the virtual demonstration room is terminated in a step 174. If no adaptation of user-specific data is to take place via the Internet 10, then a step 174 follows directly after step 170.

The FIGS. 5A and 5B show a flow chart comprising the steps which are implemented when creating user-specific data for the application program selected. The method starts in a step 200 with the actuation of the button 86 for the virtual adaptation room. In a next step 202, an adaptation page is displayed on the display unit of the service use computer 16, which page demands an input of a codeword that authorizes the adaptation. This codeword corresponds to the codeword handed over in step 172, see FIG. 4B.

In a step 204, it is verified whether a valid codeword has been entered by the user. If this is the case, the user can, in a step 206, use the application program and adapt it to his requirements. In particular, he is allowed by the service provider to also access the database computer 36 so that the user can create an own and extensive database for his own purposes. If, however, in step 204 it is determined that no valid codeword has been entered, then a step 218 for terminating the method follows directly after step 204, which step 218 will be explained in more detail below.

In a step 208 following the step 206, the user enters his own master data, for example a user of the hospital administration program will enter the number of hospital beds in specific categories, the number and kind of operating rooms and information with regard to forms.

If the user requires the help of the manufacturer for these adaptations, see step 210, he calls an application engineer of the manufacturer in step 212. The application engineer “mirrors” the user from the computer 32. The application engineer takes the identity data required for the “mirroring” from the process information list of the service provisioning computer. In step 214, the manufacturer can, due to the “mirroring”, give optimum support to the user during the adaptation.

If the user wants to carry out further adaptations, see step 216, the method is continued in step 208. The method is in a loop comprising the steps 208 to 216. When carrying out this loop, several connections might be set up between the user and the manufacturer.

The loop comprising the steps 208 to 216 is only left in step 216 if the user currently no longer wants to carry out any adaptations. In this case, the method is terminated in a step 218 and one returns to WEB page 50, i.e. the WEB page 50 is displayed on the display unit of the service use computer 16. The adaptations and amendments, which have been entered by the user up to now, are stored in the memory unit 14 of the service provisioning computer 12 and in the database of the database computer 36.

FIG. 6 shows a flowchart illustrating the steps which are implemented upon the delivery of the application program. The method starts with a step 250, wherein the button 88 for calling the virtual delivery room is actuated. In a next step 252, the virtual delivery room is displayed on the display unit of the service use computer 16. The page displayed demands the input of a codeword which authorizes that the costs are requested and the deliveries are caused.

In a step 254 it is verified whether a valid codeword has been entered. If no valid codeword has been entered, access to the virtual delivery room is denied and the method is terminated in a step 266, which will be explained in more detail below. If, however, a codeword has been entered that corresponds to the codeword handed over in step 172, step 256 follows immediately after step 254.

In step 254 the user is asked whether he wants to settle any costs which have incurred up to now during the adaptation. If costs are to be displayed or settled, a step 258, wherein the costs are displayed, follows directly after step 256. In a next step 260, the user can cause the settlement of the costs incurred up to now. Afterwards, a step 262 is carried out. If, on the other hand, it is determined in step 256 that the user does not want to settle the costs for the moment, a step 262 follows directly after the step 256.

In step 262, the user is asked whether he wants to cause the delivery of the application program selected and the user-specific data. If the delivery is to be caused, then in a step 264 the transmission of the application program and the user-specific data via the Internet connection 18, see FIG. 1, is caused. Thus, the user gets a product which has already been adapted to his requirements and of which he is fully assured that it will meet his requirements.

Afterwards, the method is terminated in a step 266. Once again, the WEB page 50 appears on the display unit of the service use computer 16.

In known methods of introducing an application program, various phases are carried out in the following order:

a) selection of the application program,

b) obtaining of the application program and installation at the user,

c) delivery of the application program adapted to the requirements of the user including database as well as installation,

d) training of the operators of the user,

e) adaptation of the application program to the requirements of the user, in particular creation of an own database,

f) termination of the starting phase, for example by means of a purchase,

g) use of the application program by the user as to the requirements of his trade, and

h) maintenance of the application program.

By using the method according to the invention, the steps are carried out in a different order:

a) selection of the application program (a),

b) training of the operators (d),

c) adaptation of the application program and creation of the user-specific data (e),

d) termination of the starting phase, for example by means of a purchase (f),

e) obtaining of a suitable hardware (b),

f) delivery of the application program adapted to the requirements of the user including database as well as installation (c),

g) use of the application program by the user as to the requirements of his own trade (g), and

h) maintenance of the application program (h).

The position of the respective phase in known methods has been indicated in brackets. By using the method according to the invention the obtaining of the hardware has been delayed to a later point of time. This leads to the fact that the user can finally work with a more modern hardware. Further, by means of the method according to the invention it is achieved that the user is protected against greater expenses if the adaptation brings about that the application program is indeed not suitable for his purposes.

### LIST OF REFERENCE NUMERALS

List of reference numerals

| | |
|---|---|
| 10 | Internet |
| P1 to Pn | application program |
| 12 | service provisioning computer (application-server) |
| 14 | memory unit |
| BS | operating system |
| 16 | service use computer |
| 18 | Internet connection |
| 20 | data display program |
| ICA | special narrowband protocol |
| B1, B2 | user |
| 22, 24 | memory area |
| PID1, | identity number |
| PID2 | |
| 26 | Internet connection |
| 28 | computer |
| 30 | Internet connection |
| 32 | computer |
| 34 | Internet connection |
| 36 | database computer |
| 50 | WEB page |
| 52 | address bar |
| 54 | title bar |
| 55 | title field |
| 56 | minimize button |
| 58 | close button |
| 60 | trade selection bar |
| 62, 64, 66 | button |
| 68 | dots |
| 70 | status bar |
| 72 | room selection field |
| 74 | information field |
| 80 to 92 | button |
| 96 | dots |
| 98 | vertical scroll bar |
| 100 | hierarchy for selection |
| 102 | program associated to the WEB page |
| 104 | Which trade? |
| 106 | Which application program? |
| 108 | Which virtual room? |
| 150 | start |
| 152 | calling the demonstration page |
| 154 | demonstration and test |
| 156 | registration |
| 158 | advice by the service provider via the telephone or the Internet |
| 160 | mirroring of the data and actions |
| 162 | Specialist required? |
| 164 | transfer |
| 166 | dialog between user and manufacturer |
| 168 | mirroring |
| 170 | Is clearing to take place? |
| 172 | codeword via manufacturer to user |
| 174 | end |
| 200 | start |
| 202 | calling the adaptation page |
| 204 | Codeword valid? |
| 206 | calling the application program with own database |
| 208 | input of the master data + adaptations |
| 210 | Is help required? |
| 212 | call |
| 214 | mirroring |
| 216 | Further inputs and adaptations? |
| 218 | end |
| 250 | start |
| 252 | calling of the delivery room page |
| 254 | Codeword valid? |
| 256 | Settlement of the costs? |
| 258 | display |
| 260 | settlement |
| 262 | Delivery? |
| 264 | via manufacturer to user |
| 266 | end |

1. A method of switching process data,
wherein a program (P1) stored in the memory (14) of a program computer (12) is executed by at least one processor in a process which is distinguishable from other processes executed by this processor by means of a process date (PID1),
having regard to the process date (PID1), data related to the execution of the program (P1) are transmitted between the computer (12) and a first interface (28) for the data input and/or data output,
it is caused by the first interface that the process date (PID1) or data for determining the process date (PID1) are transmitted to a second interface (32) (step 164),
and wherein by means of the process date (PID1) data related to the execution of the program (P1) are transmitted between the program computer (12) and the second interface (32) (step 168).

2. A method according to claim 1, characterized in that the first interface (28) and/or the second interface (32) are included in remote computers (28, 32) which are connected to the program computer (12) via a data communications network (10) or a data telecommunications network.

3. A method according to claim 1 or 2, characterized in that the program (P1) is a program which is used by a user from the first interface (28).

4. A method according to claim 1 or 2, characterized in that the program (P1) is a program which is controlled by a user from a user interface (16).

5. A method according to claim 4, characterized in that the second interface (32) is an interface of the manufacturer of the program (P1).

6. A method according to claim 5, characterized in that in the memory (14) of the program computer (12) several programs (P1, P2) are executed,
that dependent on a program (P1, P2) concerned by the process number (PID1, PID2), the transfer of the process date (PID1, PID2) or of the data for determining the process date (PID1, PID2) from the first interface (28) to interfaces (32) of different manufacturers is caused.

7. A method according to one of the claims 4 to 6, characterized in that the user interface (16) is included in a user computer (16) which is connected to the program computer (12) via a data communications network (10) or a data telecommunications network (10).

8. A method according to one of the claims 4 or 5, characterized in that the same data which are transferred between the program computer (12) and the interface used by the user are transferred to the first interface (28) and/or the second interface (32).

9. A method according to one of the preceding claims, characterized in that the process date (PID1) or the data for determining the process date (PID1) are transferred to the first interface (28),
and that the transferred process date (PID1) or the transferred data for determining the process date (PID1) are transferred from the first interface (28) to the second interface (32).

10. A method according to claim 9, characterized in that the process date (PID1) or the data for determining the process date (PID1) are transferred via a data communications network (10), a data telecommunications network (10) or via a telephone network.

11. A method according to one of the preceding claims, characterized in that in a starting phase the user inputs user-specific program parts of the program or parts of a user-specific database required for using the program without having unrestricted access to the instructions of the application program (P1),
and that the user gets unrestricted access to the instructions of the application program (P1) after the termination of the starting phase.

12. A method of creating user-specific data,
wherein an application program (P1) is stored in the memory (14) of a computer (12),
a user uses functions of the application program (P1) from a remote service use computer (16) via a data communications network (10),
the user inputs in a starting phase user-specific program parts of the application program (P1) or a user-specific database required for the use of the program without having unrestricted access to the instructions of the application program (P1),
and that the user gets unrestricted access to the instructions of the application program (P1) after the termination of the starting phase.

13. A method according to claim 12, characterized in that after the starting phase the user-specific data are stored and used on another computer (16).

14. A method according to claim 12 or 13, characterized in that the remote use of the functions by the user is displayed in a computer (28) of a service provider offering the remote use of the application program (P1) or in the computer (32) of the manufacturer of the application program (P1).

15. A method according to claim 14, characterized in that between the user and the service provider and/or between the user and the manufacturer messages are exchanged via the data communications network (10) or via another data communications network, which messages support the use of the functions and/or the adaptation (steps 158, 166, 212).

16. A method according to claim 14 or 15, characterized in that during the remote use a connection for the transfer of the messages and/or the display of the remote use is first set up between the user and the service provider and only afterwards between the user and the manufacturer.

17. A method according to claim 16, characterized in that the service provider switches the user to the manufacturer (step 164),
and that during the switching a process number (PID1) is passed on, by means of which the functions used by the user can be displayed in the computer (28) of the service provider and/or in the computer (32) of the manufacturer.

18. A method according to one of the claims 12 to 17, characterized in that in the memory (14) of the computer (12) application programs (P1 to Pn) for various applications and in particular of various manufacturers are stored.

19. User-specific data which are part of an instruction sequence of an application program (P1) or which are part of a database used by an application program (P1), characterized in that for creating the user-specific data a method according to one of the claims 12 to 18 has been used.
